(19) United States
(12) Patent Application Publication
(10) Pub. No.: US 2013/0245808 A1
(43) Pub. Date: Sep. 19, 2013

(54) GERMICIDAL TIE RACK

(71) Applicants: Daniel Page Hexter, Annapolis, MD (US); Michael Allen Barbe, Annapolis, MD (US)

(72) Inventors: Daniel Page Hexter, Annapolis, MD (US); Michael Allen Barbe, Annapolis, MD (US)

(21) Appl. No.: 13/424,305

(22) Filed: Mar. 19, 2012

(51) Int. Cl. A47F 5/025; G05B 15/00

(52) U.S. Cl. 700/214; 211/1.51

(57) ABSTRACT

A motorized tie rack that, while providing convenient storage for one's necktie collection, will sanitize the neckties with an ultraviolet light. The rack includes a “clean” button which, when pressed, will rotate the necktie to the rear of the device. There, a shielded ultraviolet light will be activated for several minutes, disinfecting both sides of the necktie.

### BACKGROUND OF THE INVENTION

The present invention relates to clothing accessories and more particularly, to a rotating motorized tie rack with an ultraviolet germicidal light.

Neckties are potential sources of infections, as they are rarely washed and can harbor disease-causing viruses and bacteria.

A conventional closet having an ultraviolet light included this light at the bottom and/or on hangers. Such a light system would not satisfactorily clean a necktie that was placed in the closet. While a portable disinfecting light could certainly be used, it would be inconvenient to have to hold the light on both sides of the tie for a sufficient amount of time for true disinfections. In addition, it would be difficult to hold the light at the correct distance to adequately disinfect the ties without being too close to damage the ties.

As can be seen, there is a need for an improved system for holding and disinfecting ties hung on a tie rack.

### SUMMARY OF THE INVENTION

In one aspect of the present invention, a tie rack comprises a plurality of conveyor hooks adapted to hold neckties; a motor adapted to move the conveyor hooks into an ultraviolet light chamber; and one or more ultraviolet lights adapted to emit ultraviolet light within the ultraviolet light chamber.

In another aspect of the present invention, a tie rack comprises a plurality of conveyor hooks adapted to hold neckties; a motor adapted to move the conveyor hooks into a ultraviolet light chamber; one or more ultraviolet lights adapted to emit ultraviolet light within the ultraviolet light chamber; a processor adapted to control the speed of the motor and the duration of the applied ultraviolet light; and one or more control buttons, the control buttons adapted to turn the one or more ultraviolet lamps on and off and to cause the motor to move the conveyor hooks.

These and other features, aspects and advantages of the present invention will become better understood with reference to the following drawings, description and claims.

### BRIEF DESCRIPTION OF THE DRAWINGS

FIG. 1 is a perspective view of a germicidal tie rack according to an exemplary embodiment of the present invention;

FIG. 2 is a cross-sectional view of the tie rack of FIG. 1; and

FIG. 3 is a front view of the tie rack of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a motorized tie rack that, while providing convenient storage for one's necktie collection, will sanitize the neckties with an ultraviolet light. The rack includes a “clean” button which, when pressed, will rotate the necktie to the rear of the device. There, a shielded ultraviolet light will be activated for several minutes, disinfecting both sides of the necktie.

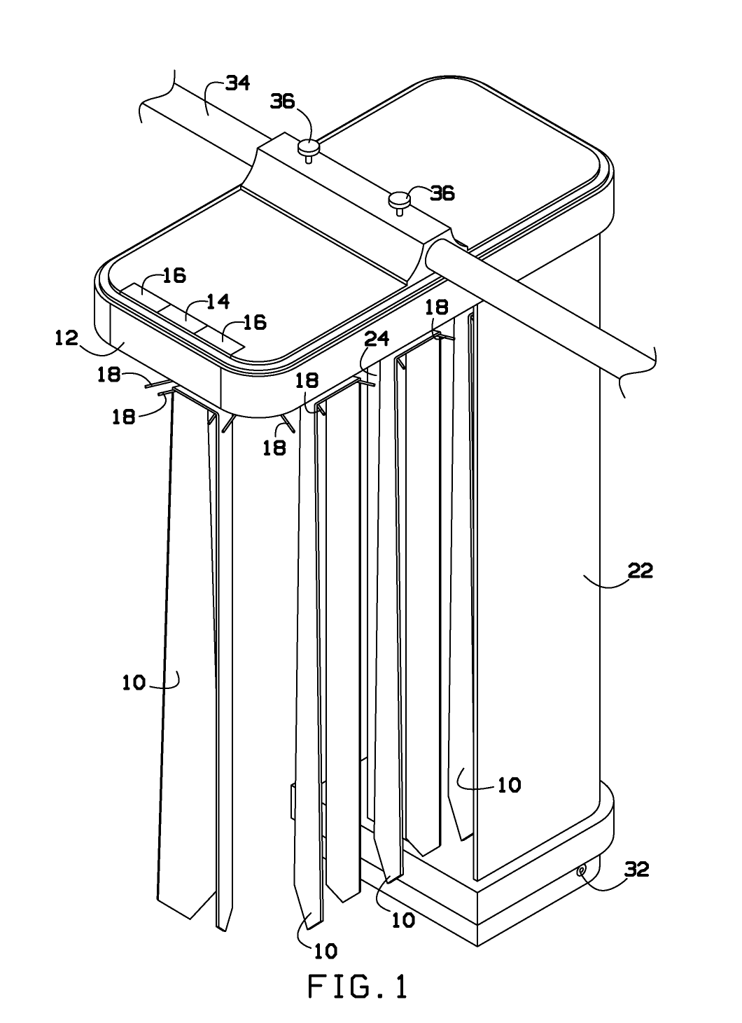

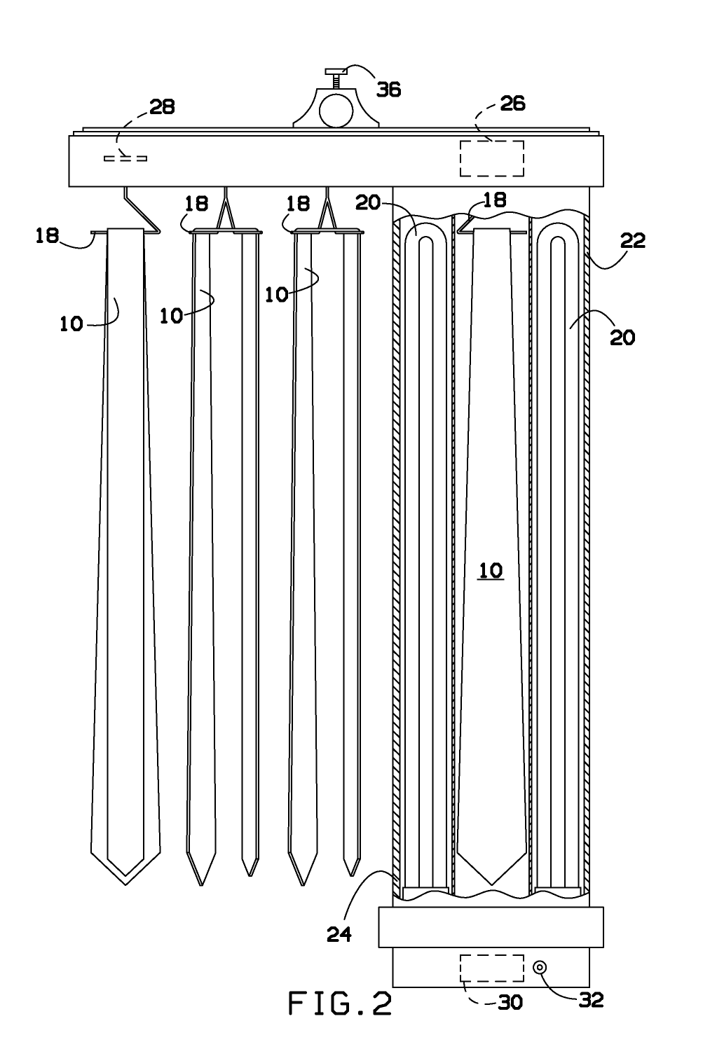

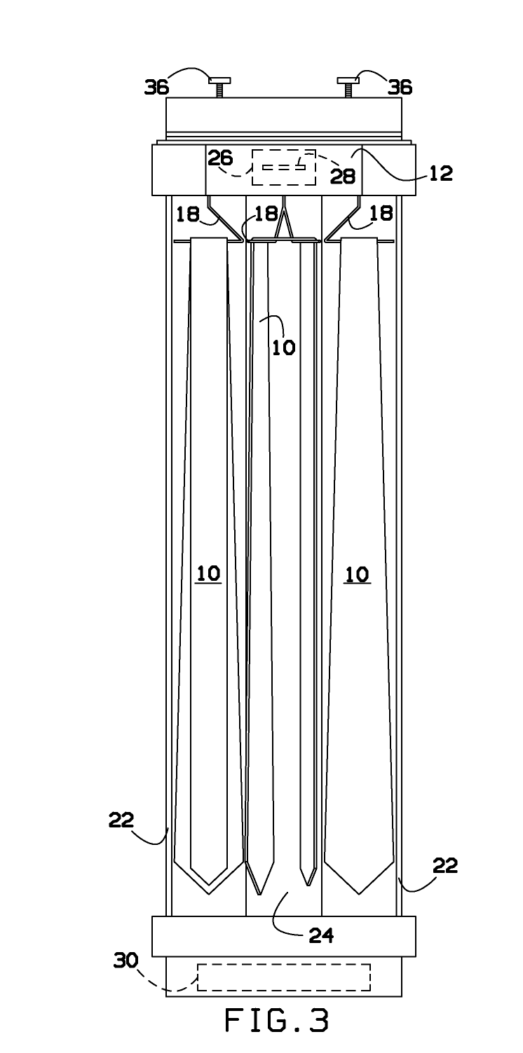

Referring now to FIGS. 1 through 3, a tie rack may include a plurality of conveyor hooks 18 for holding ties 10. The tie rack may be motorized via a motor 26 that may be powered by one or more rechargeable batteries 30 or via standard household current via an AC power connection 32. The motor 26 may move conveyor hooks 18 to move ties from an exposed area to an area encased by the tie rack. There may be from about 10 to about 50 or more conveyor hooks 18, each designed to typically hold a single tie. The motor 26, or a second motor (not shown), may be used to turn ties 10 on their longitudinal axis when being treated with ultraviolet light. In some embodiments of the present invention, the tie rack may include the ability to use one or both types of power. In some embodiments, the batteries 30 may be a removable battery pack that may be charged via the AC power connection 32 or via a separate battery charger (not shown).

A front portion of the tie rack may include an illumination light 12 to provide light for a user in a dark closet, for example. The light 12 may be activated by a switch (not shown), may automatically come on when the conveyor hooks 18 are moved by the motor 26, may be motion activated, or the like.

A plurality of buttons may be disposed on the tie rack. For example, a disinfecting control button 14 may control one or more ultraviolet lamps 20 disposed within a ultraviolet light chamber 22. The light chamber 22 may be heat resistant and may house the one or more lamps 20 such that light may be retained inside a light chamber shield 24 so that ultraviolet light does not affect a user of the tie rack. Forward and reverse conveyor rack 18 control buttons 16 may be disposed on the tie rack. The control buttons 18 may move the conveyor rack 18 either forward or backwards. In some embodiments, only a single control button 18 may be used, allowing movement only in a single direction.

The tie rack may include a mechanism to mount the tie rack. For example, one or more closet bar bolts 36 maybe adapted to clamp onto a closet bar 34 inside a closet. In some embodiments, the tie rack may be designed to mount to a wall. In other embodiments, the tie rack may be adapted to hook from the closet bar 34 without any bolts 36. The tie rack may further be adapted to mount not only in a closet, but also in an office or any other place where a user may store their ties.

A processor 28 may be disposed inside the tie rack to provide various controls. For example, the processor 28 may be used to control the duration of the light, the speed of the rotation of the rack, and the like.

In some embodiments, a user may select to disinfect only a single tie by, for example, moving the conveyor rack 18 until the tie is within the light chamber shield 24. Then, the user may press the disinfect button 14. In other embodiments, the user may select to disinfect their entire collection, where the ties 10 will move through the light chamber shield 24 and the entire collection may be disinfected.

The tie rack of the present invention may be useful for anyone that uses ties. The tie rack of the present invention may be particularly useful for persons that may carry germs or viruses while wearing a tie, such as a physician, dentist or the like.

Unlike conventional systems, which may require a user to hold a light next to their tie, the tie rack of the present invention allows a user to quickly, easily and precisely disinfect their ties, often with just the push or one or two buttons.

It should be understood, of course, that the foregoing relates to exemplary embodiments of the invention and that modifications may be made without departing from the spirit and scope of the invention as set forth in the following claims.

What is claimed is:

1. A tie rack comprising:
a plurality of conveyor hooks adapted to hold neckties;
a motor adapted to move the conveyor hooks into a ultraviolet light chamber; and
one or more ultraviolet lights adapted to emit ultraviolet light within the ultraviolet light chamber.

2. The tie rack of claim 1, further comprising a processor adapted to control the speed of the motor and the duration of the applied ultraviolet light.

3. The tie rack of claim 1, further comprising an illumination light adapted to illuminate the neckties.

4. The tie rack of claim 1, wherein the motor is powered by at least one or a battery and household power via an alternating current adaptor.

5. The tie rack of claim 4, wherein the battery is a rechargeable battery.

6. The tie rack of claim 1, further comprising one or more closet bar bolts adapted to mount the tie rack on a closet bar.

7. The tie rack of claim 1, further comprising one or more control buttons, the control buttons adapted to turn the one or more ultraviolet lamps on and off and to cause the motor to move the conveyor hooks.

8. A tie rack comprising:
a plurality of conveyor hooks adapted to hold neckties;
a motor adapted to move the conveyor hooks into a ultraviolet light chamber;
one or more ultraviolet lights adapted to emit ultraviolet light within the ultraviolet light chamber;
a processor adapted to control the speed of the motor and the duration of the applied ultraviolet light; and
one or more control buttons, the control buttons adapted to turn the one or more ultraviolet lamps on and off and to cause the motor to move the conveyor hooks.

9. The tie rack of claim 8, further comprising an illumination light adapted to illuminate the neckties.

10. The tie rack of claim 8, wherein the motor is powered by at least one or a rechargeable battery and household power via an alternating current adaptor.
